(19) United States
(12) Patent Application Publication
(10) Pub. No.: US 2008/0174737 A1
(43) Pub. Date: Jul. 24, 2008

(54) ROLE PLAYING PROJECTOR TOY

(76) Inventor: Laura ZEBERSKY, Sunrise, FL (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/970,508

(22) Filed: Jan. 7, 2008

Related U.S. Application Data
(60) Provisional application No. 60/883,689, filed on Jan. 5, 2007.

(51) Int. Cl. G03B 21/14

(52) U.S. Cl. 353/28; 353/15

(57) ABSTRACT

A role playing projector system projects an image such that a person may engage in role playing as though they are within the projected image. The system has a number of slides and a projector capable of sequentially projecting the image on each of the slides onto a display surface. The image on each one of the slides is pre-distorted such that when the projector is placed at a predetermined angle to the display surface, the images are projected on the display surface without distortion to a viewer. Thus, a person may engage in role playing in front of the projected images without casting a shadow on the projected images.

### RELATED APPLICATIONS

This application claims the priority benefit of U.S. Provisional Application No. 60/883,689 filed on Jan. 5, 2007, which is hereby incorporated by reference in its entirety.

### BACKGROUND OF THE INVENTION

1. Field of the Invention

The present invention relates to toys. More specifically, the present invention relates to a projector toy that projects an image such that a person can move so that it may appear to a viewer as though the person is acting or role playing within the projected image.

2. Background of the Related Art

Image projectors are known in which a moving image can be projected onto a screen or a wall. However, it is difficult for a person to move with respect to a projected image in a manner that a viewer can perceive that the person is interacting with the image. In particular, a person standing in front of a projected image is likely to cast a shadow on the projected image.

Some projectors are known which can be set up at the base of a projection screen and angled upwards. Even though the projector may permit the user to attempt to correct the projected image by distorting the image displayed on the output panel, utilizing keystone or other types of correction, the result is nevertheless at least a slight distortion of the projected image (a trapezoid shape with the base smaller than the top of the image).

In some circumstances, the problems are so severe that image projection is not attempted and the apparent interaction between the person and image is accomplished by other means. For example, a person reporting the weather on television typically does not stand in front of a displayed weather map. Instead the person stands in front of a blank blue screen or green screen, and the weather map is electronically inserted (chroma-keyed) into the television signal wherever the blue or green of the screen appears.

Projectors and apparatus are known which facilitate playing with a projected image, such as ViewMaster. But it can be difficult for the person to move or act appropriately if they can not see the projected images. This is especially true where the person is acting or role-playing so as to simulate interaction with the projected images. In particular, the known prior art projector toys do not allow for the positioning of a projector unit to the side and/or close to the projection surface to allow for a person to step in front of the wall with the projected image without blocking the image projection. The high cost and equipment needed for the keystone correction or for the chroma-keying solutions makes them unacceptable for use with a toy projector in role playing.

Furthermore, it is highly desirable that a projector toy apparatus permit role playing with a projected image in a manner that is effective, moderately convincing, and fun for children. The system should thus also be simple to use, compact, cost effective, and portable. Accordingly, there is a need for an improved projector toy and system designed for role playing.

### BRIEF SUMMARY

An objective of the preferred embodiments is to make a projection apparatus that projects an image onto a flat wall from in front of the wall, but allows for someone to stand in front of the same wall and use the projection as a back-drop for play acting. The high angle projection image is displayed sideways onto a display wall so that a person can stand in front of the projected image and appear to a distant viewer to be an actor within the image without shadows or other constraints. The projector is to be placed in an out of the way position so as to not interfere with the play acting, so it must either be very closely situated to the wall, positioned to one side, or both.

The preferred embodiments of the invention thus utilize a portable slide projection unit that is designed to be placed on the floor in front of a common flat wall and to project a non-distorted image onto that wall. The film or other types of images on the slides are of two different types. The first type of image is a conventional image that is projected squarely onto a wall. The second type of image is pre-distorted to match the projection angle so that the projector may be placed in an out-of-the-way location to one side of the projected image. The purpose of the second type of images is to create a projected background image that can be used for play acting without disrupting the projected image (creating shadows) or projecting the image onto the actors themselves.

Another object of the preferred embodiments is to provide a role playing environment and system utilizing a projector enabling a person to play along as part of one or more projected scenes and thereafter controllably switch between scenes. The story slides may be easily interconnected in different sequences so that scenes can be projected in different sequences as well. The slides are easily loaded and controlled by the touch a single button on the projector apparatus itself. The projector apparatus may also include various sound effects that may be selected and played by the user and/or an input that allows music to be provided and played while the role playing takes place. Furthermore, there may be a remote device that permits the person doing the role playing to control the changing of the slides, sound effects and input music without having to be near the projector apparatus. This remote device may also be a microphone that permits the person doing the role paying to be singing and have their voice amplified by the projector apparatus.

### BRIEF DESCRIPTION OF THE DRAWINGS

The above, and other objects, features and advantages of the present invention will become apparent from the following description when read in conjunction with the accompanying drawings, in which like reference numerals designate the same elements.

FIG. 1 is a perspective view of a projector toy apparatus according to one preferred embodiment of the invention.

FIG. 2 is a top view of the controls of the projector toy apparatus according to the preferred embodiment shown in FIG. 1.

FIG. 3 is an illustration of two types of slides which may be used in conjunction with the projector toy apparatus according to the preferred embodiment shown in FIG. 1.

FIG. 4 is an illustration of the sideways projection of an image onto a display wall according to a first application of the projector toy apparatus in FIG. 1.

FIG. 5 is an illustration of the projection of an image squarely onto a display wall according to a second application of the projector toy apparatus in FIG. 1.

FIG. 6 is a perspective view of a plurality of slides connected to each other in a preferred embodiment of the invention.

FIG. 7 is a view showing the connecting elements of two slides in the preferred embodiment of the invention shown in FIG. 6.

FIG. 8 is a perspective view showing a removable slide cover in the preferred embodiment of the slides shown in FIG. 6.

FIG. 9 is another perspective view of the projector toy apparatus showing an internal slide drive mechanism according to a preferred embodiment of the invention.

FIG. 10 is a perspective view of the slide drive mechanism for forwarding slides in the projector toy apparatus according to a preferred embodiment of the invention.

FIG. 11 is another perspective view illustrating the translational movement of a platform in response to the rotation of a motor in the slide drive mechanism of FIG. 10.

FIG. 12 is an enlarged view of the electrical contact switch in the slide drive mechanism of FIG. 10.

FIG. 13 is an exploded view showing key components of the slide drive mechanism of FIG. 10.

FIG. 14 is a front view of the slide drive mechanism of FIG. 10, showing the slide in relation to the translation movement of the platform.

FIG. 15 is a view of the slides located in the slide drive mechanism along line 15-15 of FIG. 14.

FIGS. 16-18 are views showing different respective positions of the slides and the slide driving mechanism during the switching of slides.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

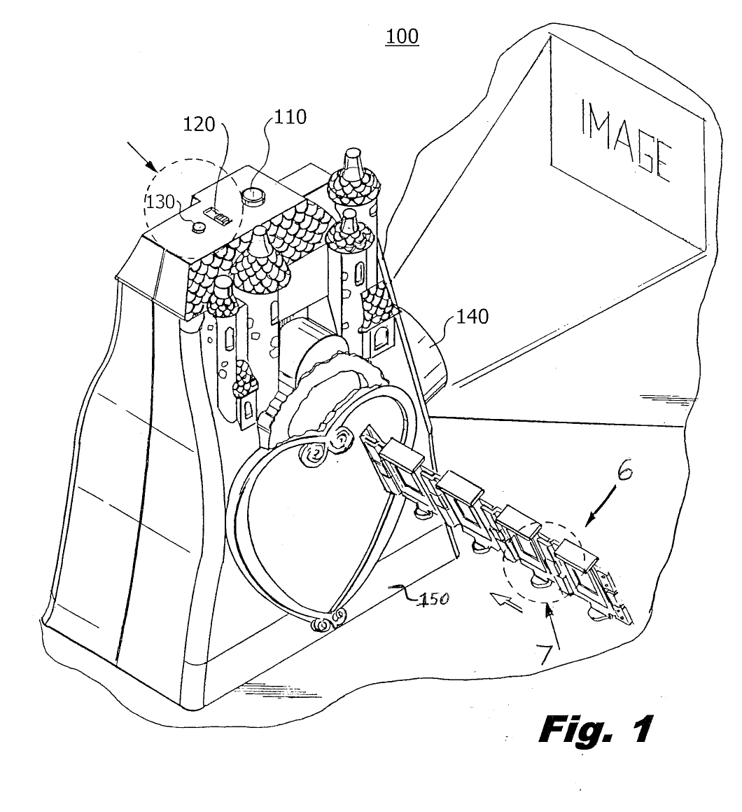

Referring now to FIG. 1, the projector apparatus 100 in an exemplary role playing system includes a housing structure containing a projector having an enclosed illumination source as well as enclosed optical elements for projecting an image in a forward direction so as to appear on a wall or other display surface. The base 150 of the housing comprises a fixed outline, which assists in positioning the projector apparatus 100 at a proper predetermined angle to the display surface. The projector apparatus 100 also includes at least a focusing lens 140 on the exterior of the housing, which is rotated in a known manner to adjust the focus of the projected image.

Additionally, various audio and visual electronic controls are positioned on the housing. These controls include a slide button 110 for advancing slides through the projector in a manner as described hereafter or in some other manner, and an on-off switch 120. The controls may also include a standard audio input 130 for accepting an audio jack from a MP3 player or other audio source, and various sound effect buttons which, when selected, cause the projector apparatus to play a corresponding predetermined sound effect.

These controls may be grouped together on the top of the projector apparatus 100 as shown in FIG. 2, or may be located in any other manner. The speaker for producing the sound and the electronics for operating as described herein are preferably located inside the housing. The electronics are preferably mounted on a circuit board, the location and details of which are dependent on the housing. It should be apparent that the housing, the design and other parts of the projector apparatus and remote control may be in accordance with a particular theme, such theme being represented as well in the sound effects and scenes represented by the images on the slides.

Although not illustrated, projector apparatus 100 also includes an infrared or other type of receiver for receiving signals from a remote control device. The receiver is preferably included on an exterior surface of the projector apparatus 100 in a manner so that it is somewhat visually obscured and yet able to receive signals from the remote control device. The remote control may be designed in a manner appropriate to the theme. For example, it may be a microphone, or a magic wand, or other appropriate prop. The remote control duplicates the controls available on the apparatus itself. Thus, the user can change the slide to be projected, or choose a sound effect to be played. In the instance of the remote control being a microphone, the person can sing into the microphone and the their voice can be played through the speaker of the apparatus. Projector apparatus 100 may also include a power input jack (not shown) located in the housing of projector apparatus 100 for receiving power cord from an AC electrical outlet, preferably through an adapter and cord that provides a DC voltage.

Projector apparatus 100 includes two asymmetrical slots on opposite sides of the housing, which are sized and dimensioned for receiving and passing a plurality of slides 600 through the projector apparatus 100 in a direction perpendicular to the direction of the projected image. As discussed further below, the slides include side tab elements which serves several purposes, one of which is to ensure that the slides can only be inserted into one side of the projector apparatus 100.

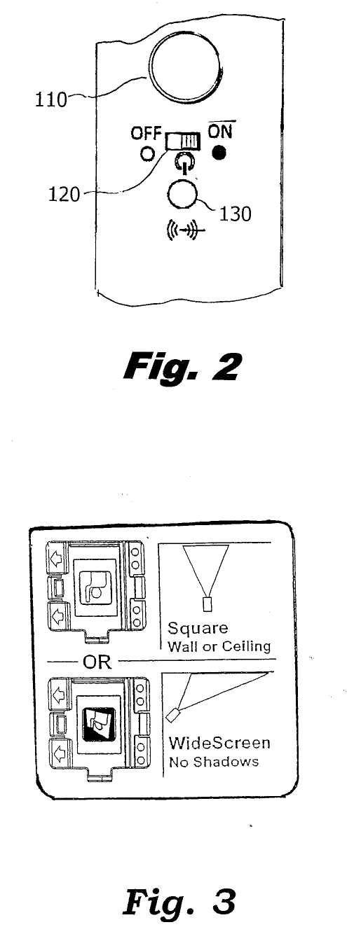

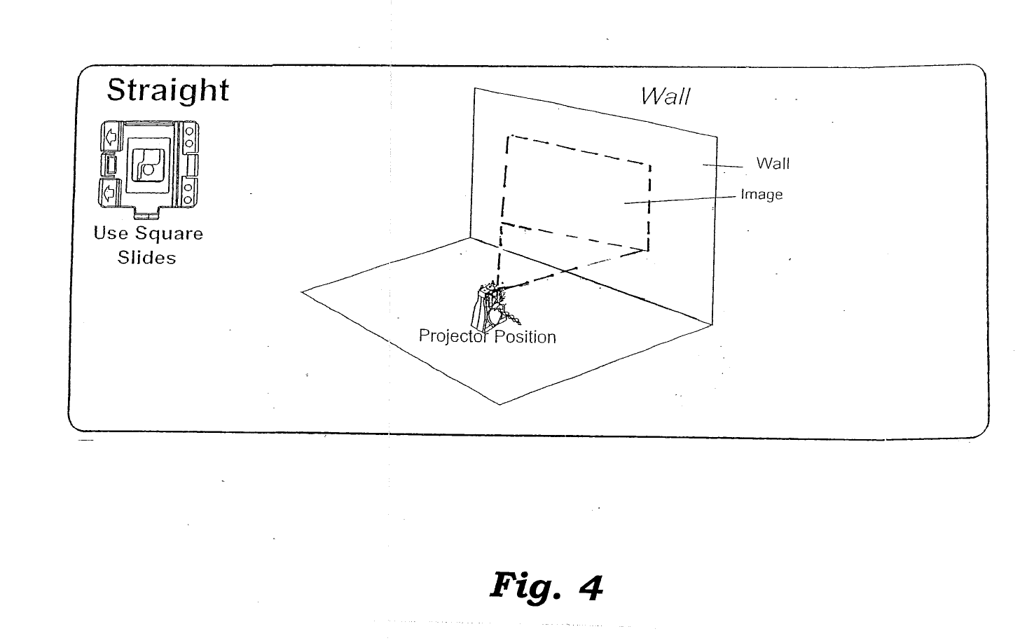

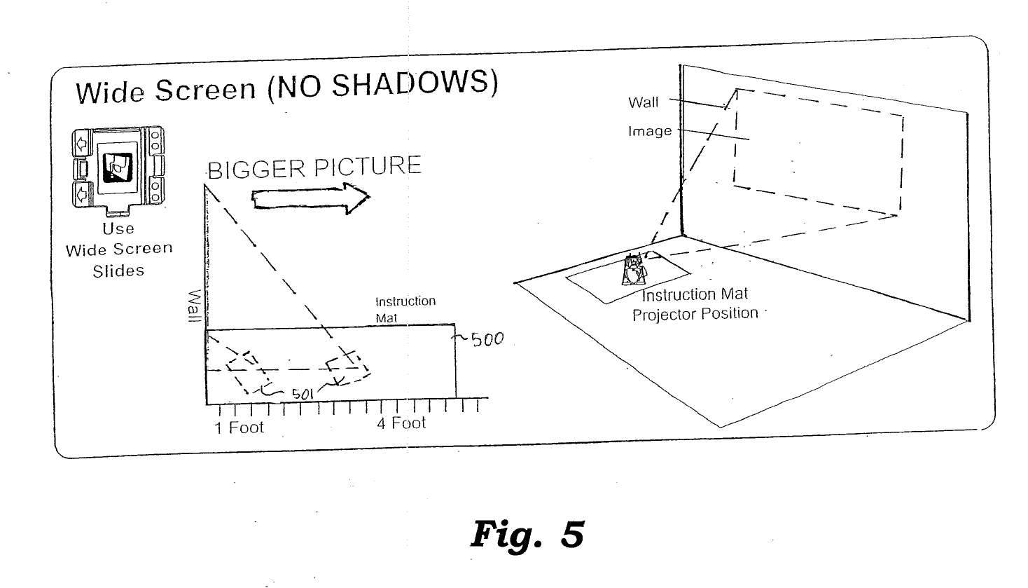

The slides 600 in the system include images of two different types as illustrated by reference to FIGS. 3-5. The first type of image is a conventional image that is projected squarely onto a wall or ceiling at an incident angle of 90 degrees. See FIG. 4. The second type of image is pre-distorted to match the projection angle so that the projector may be placed in an out-of-the-way location to one side of the projected image. The purpose of the second type of images is to create a projected background image that can be used for play acting without disrupting the projected image (creating no shadows) or projecting the image onto the actors themselves. See FIG. 5. This type of image also has the advantage that it will be a wider screen image as compared to the squarely projected image of FIG. 4, thus making it more amenable as a background for acting or role playing.

The projected image in FIG. 5 is projected at an angle so that a person standing in front of the display wall will not cast a shadow onto the projected image as a result of the projection. The image to be projected is skewed so that when it is displayed at a preset angle to the display wall, the result to a viewing gallery member will be a true perspective image. The slide or film images themselves are pre-distorted to match the projection angle so that the projector may be placed in an out-of-the-way location to one side of the projected image.

To assist in the proper projection of the widescreen image of FIG. 5, the role playing system preferably includes an instruction mat 500. The instruction mat 500 includes various outlines 501 which exactly match the outline of the base 150 of projector apparatus 100. These outlines 501 are located such that, when the end of the mat is placed adjacent to, or parallel to, the wall, and the projector apparatus base 150 is placed into an outline 501, the angle of projection of the image exactly corresponds to the pre-distortion in the images on the widescreen slides 600 such that the widescreen image is projected so as to be substantially square on the wall without trapezoidal or other distortion in the resulting projected image. Furthermore, although the picture will become bigger as the projector apparatus is placed on an outline farther away from the wall, the projected image will be the same because the angle will stay the same. It should be understood that the incident angle between the projection direction of projector apparatus 100 and the wall or other display surface is desirably quite small and as close to, for example, 10-15 degrees as practical without unacceptably diminishing the quality of the projected image. The acceptable incident angle will be determined in large part by the quality of the illumination source and optical elements of the projector apparatus.

Although only two types of images are shown in FIGS. 3-5, it should be understood that the preferred embodiment can work with three or more different types of images with different degrees of pre-distortion. The same projector apparatus can be used with each type of image, the only difference being that a different instruction mat with outlines 501 at different angle would be included in the system to correspond to the different degrees of pre-distortion.

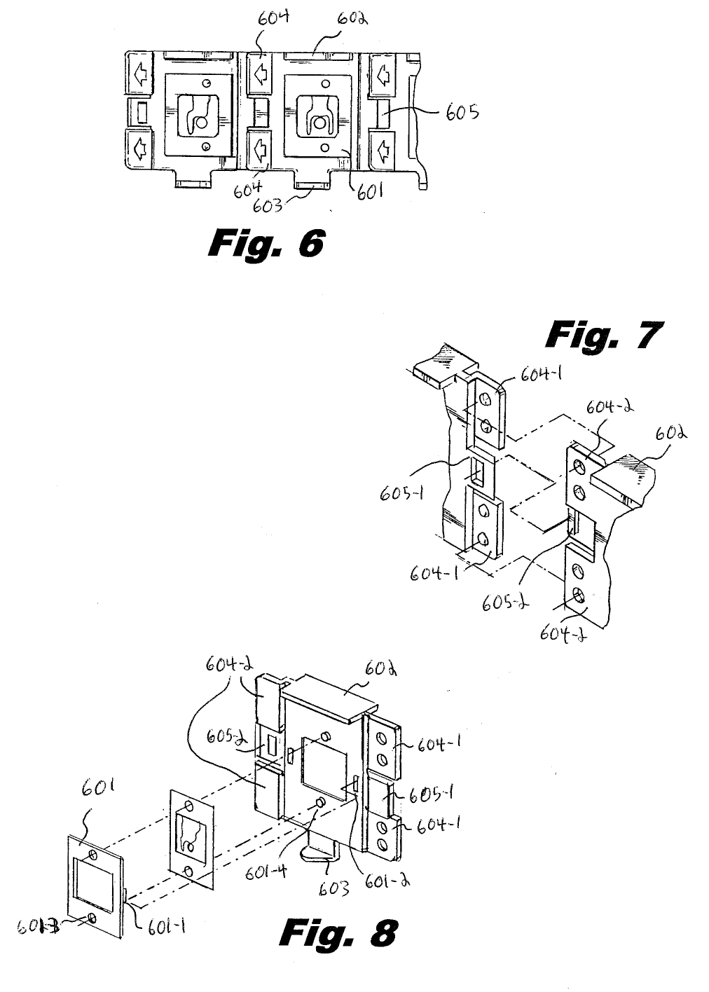

FIGS. 6-8 show the details of the slides 600 according to a preferred embodiment of the system. The slides 600 are each composed of a hard plastic or similar material, and include a cover 601 for the photographic image or film, a top spacer 602, a side protruding tab 603, top and bottom connecting elements 604, and central connecting tab 605. As shown in FIG. 8, cover 601 is preferably removable to permit the changing of the film or image in the slide. Cover 601 has tabs 601-1 that fit into holes 601-2 in slide 600 and holes 601-3 that receive raised buttons 601-4 of slide 600. Tabs 601-1 and raised buttons 601-4 have lips so that when removable cover 601 is in place, a certain amount of applied force is necessary to separate removable cover 601 from slide 600.

Top spacer 602 is a symmetrical horizontal member on the top of slide 600 which helps support the slide 600 as it is passes through projector apparatus 100. The top of top spacer 602 is even with the rest of the top of slide 600. Side protruding tab 603 protrudes from the bottom of slide 600 and is not even with the rest of the bottom of slide 600. Furthermore, lip 603-1 asymmetrically protrudes to only one side of slide 600. The asymmetrical slots in projector apparatus 100 match the asymmetry of lip 603-1. In addition to being used to drive slides through projecting apparatus 100 as described below, lip 603-1 of side protruding tabs 603 ensures that slides 600 can only be put into the slots of projector apparatus 100 in one direction. In addition to lip 603-1, arrows may also be printed or raised on top and bottom connecting elements 604 to indicate the proper direction for inserting slides 600 into projector apparatus 100.

The slides should go through the projector apparatus 100 only in one direction not only to simplify design of the mechanism for changing the slides as described below, but also to ensure that the pre-distortion in the widescreen slides matches the sideways projection of the images. When images are projected from the side as shown in FIG. 5 and they are not pre-distorted, the image will be taller at the side of the image farthest from the projector than the side of the image closest to the projector. Thus, the pre-distortion in the images is similarly asymmetrical making the far side of the image shorter and the closest side of the image taller than it would be without the pre-distortion. If the slides are not inserted into the projector in the proper direction, then the asymmetrical pre-distortion in the slide will be erroneously applied.

Top and bottom connecting elements 604 and central connecting tab 605 permit slides to be removably connected to each other. Top and bottom connecting elements 604 include offset portions 604-1 that have raised tabs on one end of a slide 600 which match up with holes in an opposing portion 604-2 of an adjoining slide that are straight with the slide and not offset. Central connecting tab 605 includes a straight portion 605-1 with a hole on one slide that receives an opposing offset portion 605-2 with a raised tab of an adjoining slide. As shown in FIG. 7, these parts interconnect such that two slides can be snapped together easily by hand, but only in an arrangement so that one end of a slide (having top and bottom connecting element offset portions 604-1 and central connecting tab straight portion 605-1) can snap with a different end of another slide (having top and bottom connecting element straight portions 604-2 and central connecting tab offset portion 605-2). The slides once snapped together in a sequence desired by the user, then pass through projector apparatus.

Although each slide is the same in the embodiment described above, different embodiments are possible. For example, the tabs and holes in top and bottom connecting elements 604 and central connecting tabs 605 for slides containing square images for the projector position shown in FIG. 4 may be in different locations and sizes than the tabs and holes in top and bottom connecting elements 604 and central connecting tabs 605 for slides containing widescreen images for the projector position shown as in FIG. 5. This prevents slides for one projector position from being mistakenly connected to and interspersed among slides from the other projector position. (Of course, even in such an alternative embodiment the top spacer 602 and side protruding tab 603 must be the same for each and every slide because these elements are necessary for proper operation of the slides in the projector apparatus.) Alternatively, the slides for different projector positions and different types of images may be distinguished by having the slides for one type being of a different color or some other visually identifiable characteristic.

An important aspect of the role playing environment is the flexibility provided by the preferred embodiment insofar as slides may be connected in any one of a different sequences and combinations. The images may represent different scenes, locations or background. Someone may script their acting or role playing entirely differently knowing that the scenes, locations or backgrounds may be in any order. They may synchronize music or other sounds to correspond to the different sequence of scenes corresponding to different slides that they themselves decide.

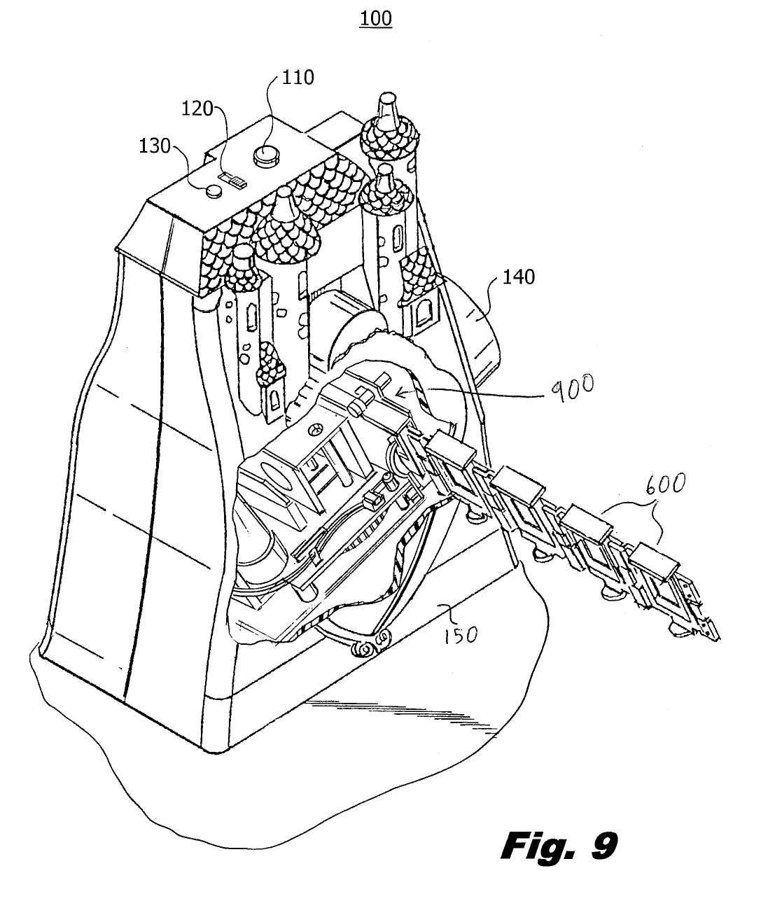

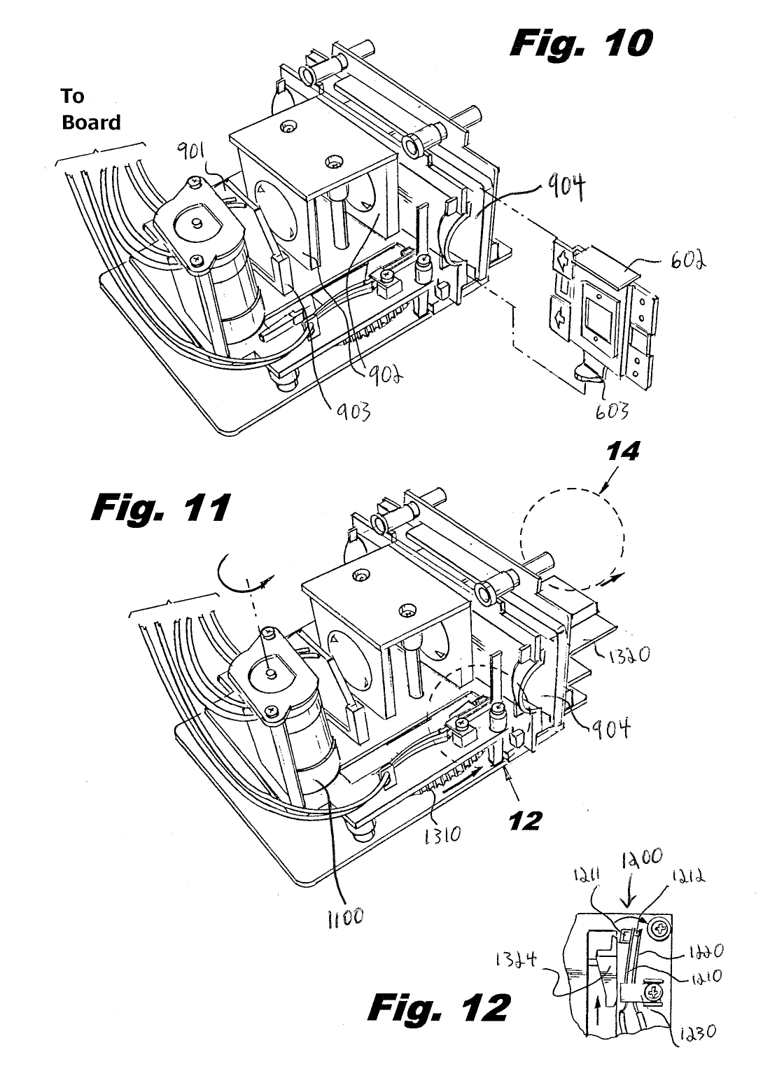

Another perspective view of projector apparatus 100 cutaway to show the positioning of a projection mechanism 900 therein is provided in FIG. 9. The projection mechanism 900 includes an illumination source 901 and a plurality of optical lenses 902. Although two lenses are shown in FIGS. 9 and 10, any number of optical lenses may be used. The illumination source 901 preferably includes a high intensity light emitting diode or other light emitting element mounted fixedly and directly onto a substrate, such as a circuit board. Preferably, the substrate is relatively small in size, contains little or no electronics, and is held in position by a substrate mount 903. A pair of wires connects the substrates to a circuit board (not shown) having electronics which turn the light emitting element on and off such as by, controllably applying a voltage to the wires. In keeping with the design objectives of the preferred embodiment stated previously, the light emitting element is preferably inexpensive, simple and compact.

The slides 600 pass through a channel 904 formed in front of, and perpendicular to, the light emitted by the light emitting element and projected by optical lenses 902. The correct vertical position of the slides 600 are ensured by top spacer 602 and side protruding tab 903 in channel 904. The correct horizontal position of the slide so that the image is centrally located in front of the projected light is ensured by the slide driving mechanism described below. The light passes through the image on slide 600 and is focused by focusing lens 140 located on the housing of projector apparatus 100.

As shown in FIGS. 11 and 12, other wires provide electrical connections between the circuit board (not shown) to a small motor 1100 and from an electrical contact switch 1200. When slide button 110 is pressed, the small motor 1100 rotates for a brief period of time. As described in detail below, the rotation of small motor 1100 results in slides 600 being moved through channel 904 so that the next slide in the sequence is moved into position in front of illumination source 900 and projected onto the wall. In addition to slide button 110, the remote control may also be operated to provide a signal indicating that the next slide in the sequence should be projected. These inputs are each received on the circuit board, which then provides the same signal to small motor 1100 regardless of whether the control is initiated from the remote control or the apparatus itself. Other signals may also be sent when the slide button 110 is pressed. For example, the illumination source 901 may be turned off and/or any audio may be muted while the slide is changed.

Electrical contact switch 1200 consists of two electrically conducting fingers 1210 and 1220 secured in position by mount 1230 so as to be extending near and parallel to each other through their entire length. The fingers 1210 and 1220 are easily moved in a horizontal direction. At the end of finger 1210 farthest away from mount 1230, there is a contact element 1211 on the left side and a small raised metal contact 1212 on the right side. When small motor 1100 rotates, it rotates (preferably through a series of reduction gears) gear 1310 in the direction shown in FIG. 11, which in turn causes translational movement of platform 1320 in the direction shown by the arrows in FIGS. 11 and 14. Since platform position part 1324 is part of platform 1320, it moves the same as platform 1320 (in the direction of the arrow shown in FIG. 12) and thus its position is also indicative of the position of platform 1320. Platform position part 1324 is located so that, as platform 1320 moves close to its most forward position, platform position part 1324 comes into contact with contact element 1211 of finger 1210 and urges finger 1210 to bend horizontally such that metal contact 1212 comes into contact with finger 1220. When the connection is made, it is detected at the circuit board through wires connected to fingers 1210 and 1220.

Since platform 1320 approaches its most forward position as part of the process of changing slides, electrical contact switch 1200 provides a useful indication to the projection apparatus that the slide is changing. This indication may be used to ensure that the motor 1100 is operated properly. The indication may also be used control other aspects of the operation of projector apparatus 100.

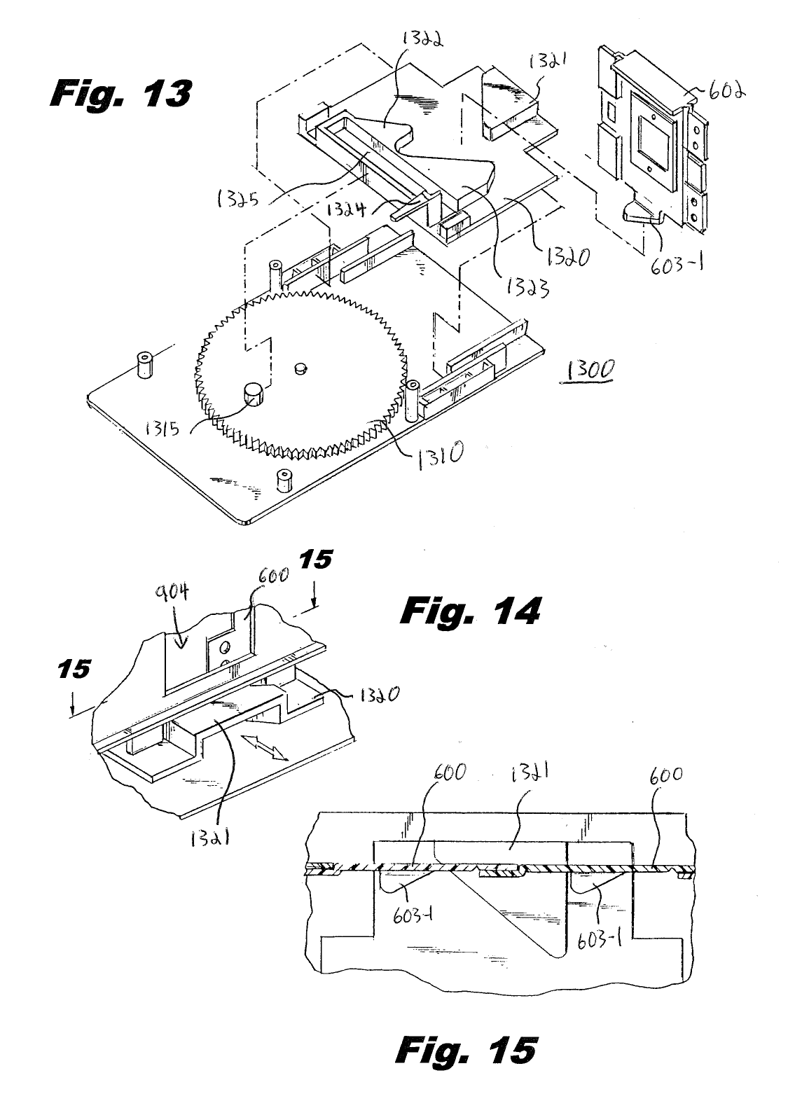

Rather than a complicated sprocket mechanism to move and change the slides in the projector apparatus 100, the preferred embodiment includes a simplified slide changing mechanism as shown in FIGS. 13 and 14, and a simple operation for changing a slide is illustrated by FIGS. 15-18. FIG. 13 is an exploded view showing the key components. At the bottom is gear 1310, which is turned by rotation of motor 1100. Platform 1320 is supported to be above gear 1310 and below channel 904 having slide 600, and to be able to move in a single forward/backward direction as shown in FIGS. 11 and 14. Gear 1310 has a cam 1315 which fits into a slot 1325 formed in platform 1320. As gear 1310 rotates once, cam 1315 moves platform 1320 into a single front and back reciprocating motion.

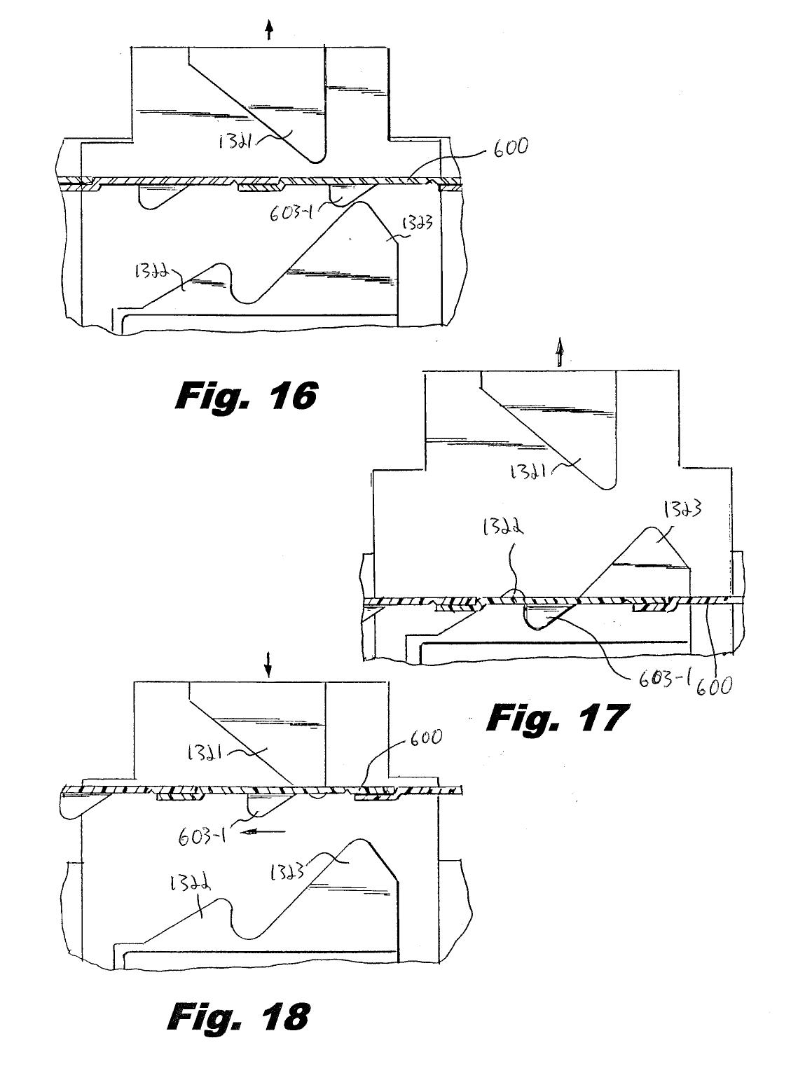

Platform 1320 includes raised landing portions 1321-1323. As shown in FIG. 14, landing portion 1321 is raised and comes into contact with side protruding tab 603 extending down from slide 600 in channel 904. FIG. 15 shows the horizontal position of two slides 600 with respect to landing portion 1321 while it is being illuminated and projected. (The vertical position of slide 600 is always the same.) Side protruding tabs 603 of these slides are on either side of raised landing portion 1321. As the reciprocating motion begins and platform 1320 moves forward as indicated by the arrow in FIG. 16, lip 603-1 of side protruding tab 603 will come into contact with the leading point of raised landing portion 1323. Due to the slope of lip 603-1 and raised landing portion 1323, lip 603-1, and thus slide 600, will be urged to the left as platform 1320 moves forward until it comes into a position between raised landing portions 1322 and 1323 as shown in FIG. 17. As platform 1320 moves backward, lip 603-1 will come into contact with the leading point of raised landing portion 1321 as shown in FIG. 18. Due to the slope of lip 603-1 and raised landing portion 1321, lip 603-1, and thus slide 600, will be urged to the left of raised landing portion 1321 and lip 603-1 of a new slide 600 will be located to the right of raised landing portion 1321 as shown in the starting position of FIG. 15.

Having described at least one preferred embodiment with reference to the accompanying drawings, it is to be understood that the invention is not limited to those precise embodiments, and that various changes, modifications, and adaptations may be effected therein by one skilled in the art without departing from the scope or spirit of the invention.

We claim:

1. A role playing projector system projecting an image such that a person may engage in role playing as though they are within the projected image, said system comprising:
a projector; and
a plurality of slides, said projector being capable of sequentially projecting the image on each of said plurality of slides onto a display surface, the image on each one of said slides being pre-distorted such that when said projector is placed at a predetermined angle to the display surface, the images are projected on the display surface without distortion to a viewer, and the person may engage in role playing in front of the projected images without casting a shadow on the projected images.

2. A role playing projector system as recited in claim 1, wherein said system includes a projection mat, said projection mat indicating the predetermined angle of the projector to the display surface when an edge of the mat is placed at or parallel to the display surface.

3. A role playing projector system as recited in claim 2, wherein said projection mat includes at least one outline, said at least one outline matching the base of said projector.

4. A role playing projector system as recited in claim 1, wherein said plurality of slides may be interconnected in different sequences.

5. A role playing projector system as recited in claim 4, wherein each one of said plurality of slides has opposing connecting elements so that one end of any slide can only be connected to a different end of another slide.

6. A role playing projector system as recited in claim 5, wherein each one of said plurality of slides includes at least one tab, said at least one tab causing said slide to have an asymmetrical cross section.

7. A role playing projector system as recited in claim 6, wherein said projector has two slots and a channel therebetween for passing said plurality of slides in front of a projection mechanism, said two slots and channel therebetween having an asymmetrical cross section permitting said plurality of slides to be input in only one direction.

8. A role playing projector system as recited in claim 7, wherein said slides are changed in response to operation of either a slide button on the projector or a slide button on a remote control for the projector.

9. A role playing projector system as recited in claim 8, wherein said projector permits the player in the role playing to select sound effects to be played by the projector.

10. A role playing projector as recited in claim 8, wherein said projector plays audio sound input into the projector while projecting the images.

11. A role playing projector as recited in claim 8, wherein each one of the plurality of slides include a side protruding tab, and the slides are changed by a platform moving in a direction parallel to the projection direction and interacting with the side protruding tabs so as to move the slides in a direction perpendicular to the projection direction.

12. A role playing projector as recited in claim 11, wherein the projector includes an electrical contact switch detecting when the slides are changed.
